(19) United States
(12) Patent Application Publication
(10) Pub. No.: US 2015/0340106 A1
(43) Pub. Date: Nov. 26, 2015

(54) SYSTEM FOR THE IN-LINE CHARACTERISATION OF CORROSION PRODUCTS

(71) Applicant: AREVA, Courbevoie (FR)

(72) Inventor: Karsten NOWOTKA, LE CREUSOT (FR)

(73) Assignee: AREVA, Courbevoie (FR)

(21) Appl. No.: 14/761,754

(22) PCT Filed: Jan. 17, 2014
(86) PCT No.: PCT/EP2014/050900

§ 371 Date: Jul. 17, 2015

(30) Foreign Application Priority Data
Jan. 18, 2013 (FR) 1350436

(51) Int. Cl. G21C 17/022; G01N 15/06

(52) U.S. Cl. CPC G21C 17/022; G01N 15/0618

(57) ABSTRACT

A system for the in-line characterisation of corrosion products in a cooling system of a nuclear reactor, the characterisation system having a tube connected to the cooling system of the reactor in which the coolant circulates, the system including at least two filters in series, the downstream filter having a smaller pore size than the filter located upstream, the filters being suitable for the coolant to pass therethrough; and differential pressure sensors combined with each of the filters making it possible to determine in-line the obstruction rate of each of the filters.

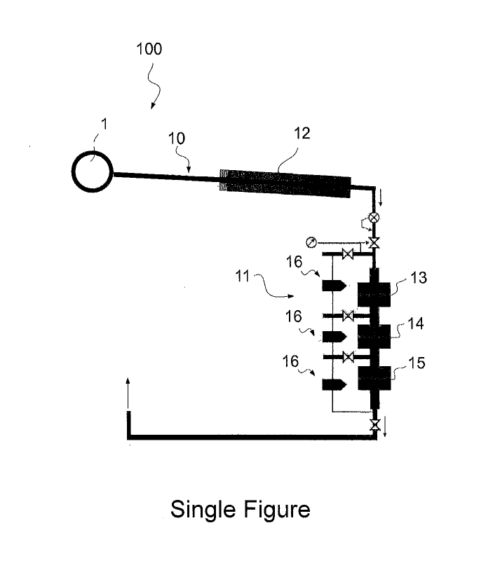

### TECHNICAL FIELD

The field of the invention is that of the in-line characterisation of corrosion products that are formed in the primary and secondary circuit of a nuclear reactor.

### PRIOR ART

In the primary and/or secondary circuit of a nuclear reactor, there is a certain corrosion of the circuit that is produced that results in the formation of corrosion products which are partially soluble in the primary and/or secondary water of the circuit. These colloids of corrosion products have a solubility in water which can decrease when the temperature of the water increases.

As such, during the operation of the nuclear reactor, the water of the primary circuit which has a high temperature is loaded with insoluble solid corrosion products, resulting in contamination with radioactive products and possibly degradation in certain portions of the primary circuit due to formation of solid deposits.

In the secondary circuit, the colloids of the corrosion products participate in the phenomenon of the forming of a deposit in the steam generators, as such resulting in a drop in the output of the central yield and possibly with a degradation in the secondary circuit.

Consequently, it is necessary to be able to control, during the operation of the reactor, the content as well as the concentration in solid and insoluble corrosion products in the primary and/or secondary circuit of the reactor.

However, this operation of control poses certain problems, on the one hand due to the very small size of the particles of the solid and insoluble corrosion products, and on the other hand, due to the substantial variations in solubility in water of these products between the ambient temperature and the operating temperature of the reactor.

An analysis system is known that makes it possible to measure the quantity of particles retained on a filter by differential measurement on two samples taken of which only one is filtered, as is described in document GB-A-1278784, wherein the samples are analysed by absorption or reflection of electromagnetic radiation.

Document EP-B1-0077258 also describes an analysis device making it possible to determine the quantity of particles retained on a filter by carrying out a differential measurement on two samples taken, with a single sample being filtered in the temperature and pressure conditions of the liquid in the cooling system, with the filtered sample then being analysed and compared with the second sample by conventional analysis means of colorimetry or spectrometry.

However, the known systems do not make it possible to continuously determine the concentration as well as the nature of the solid insoluble particles present in the coolant during the operation of the nuclear reactor.

### DISCLOSURE OF THE INVENTION

In this context, the invention aims to propose a system for the in-line characterisation of corrosion products in a primary and/or secondary circuit of a nuclear reactor making it possible to characterise, continuously during the operation of the nuclear reactor, the change in the concentrations of the corrosion products in the cooling system.

To this end, the invention proposes a system of in-line characterisation of corrosion products in a cooling system of a nuclear reactor, said characterisation system having a tube connected to the cooling system of the reactor in which the coolant circulates, the system characterised in that it comprises:
at least two filtering means in series, with the downstream filtering means having a smaller pore size than the means of filtering located upstream, with the means of filtering being suitable for the coolant to pass therethrough;
differential pressure sensors each associated with means of filtering making it possible to determine in-line the obstruction rate of each of the filtering means.

Thanks to the device according to the invention, corrosion products can also be classified by particle size, constantly, thanks to the use of a filtration in series by means of two filters having different filtering characteristics.

The characterisation system according to the invention therefore makes it possible to identify, continuously, the nature of the particles as well as the quantity of the corrosion products in the cooling circuits (primary circuit and secondary circuit) of a nuclear reactor.

This characterisation is carried out advantageously, without modifying the conditions (temperature, pressure, oxygen content, hydrogen content) of the liquid during characterisation.

As such, the system according to the invention makes it possible to avoid an operation of analysis carried out periodically via conventional means of analysis. The system according to the invention also makes it possible to avoid human manipulation and a systematic opening of the system for the carrying out of analyses of samples.

Such a characterisation system of the invention would also make it possible to better apprehend the volume and surface activities in radionuclides of the section, to compile an inventory of the corrosion products of the section and to develop membranes and filters for purification that are suited to the needs of the market.

The characterisation system according to the invention can also have one or several of the characteristics hereinbelow taken individually or according to any technically permissible combinations:
the system comprises three filtering means in series that have different filtering characteristics;
a first filtering means has pores of which the size is between 3 μm and 5 μm;
a second filtering means has pores of which the size is between 0.4 μm and 0.6 μm;
a third filtering means has pores of which the size is between 0.01 μm and 0.1 μm;
the system comprises, upstream of the means of filtering, means of cooling in order to cool the coolant circulating in the characterisation system;
the means of filtering make it possible to cool the coolant between 18° C. and 25° C.;
the system comprises means for maintaining a pressure between 1 and 15 bars on the filtering means.

### BRIEF DESCRIPTION OF THE FIGURES

Other characteristics and advantages of the invention shall appear more clearly in the description provided hereinbelow, for the purposes of information and in no way restricted, in reference to the single FIGURE that diagrammatically shows a characterisation system according to the invention.

### DETAILED DESCRIPTION OF AT LEAST ONE EMBODIMENT

The single FIGURE shows a diagrammatical view of the system for the in-line characterisation of corrosion products in a cooling system of a nuclear reactor according to the invention.

The characterisation system 100 according to the invention is an apparatus that makes it possible to carry out a filtration in series, in-line (i.e. continuous during the operation of the reactor). The system 100 comprises a tube 10 connected by a tapping of the cooling system 1 of the reactor (primary or secondary circuit) in such a way as to allow for a constant circulation of the coolant in the tube 10, in the direction indicated by the arrows. The coolant passes through a filtration apparatus 11, 21 comprised of three filtering membranes referenced respectively as 13, 14 and 15 according to the direction of circulation of the liquid in the tube 10. Each one of the membranes 13, 14, 15 has a different pore size, with the membrane positioned downstream having a smaller pore size than the membrane positioned upstream. As such the filtration apparatus makes it possible to characterise the distribution in size of the corrosion products in the form of colloids (i.e. between 1 nm (nanometre) and 1 μm (micrometre)).

Advantageously, the first filtering membrane 13 has pores of which the size is between 3 μm and 5 μm.

Advantageously, the second filtering membrane 14, located downstream of the first membrane 13, has pores of which the size is between 0.4 μm and 0.6 μm.

Advantageously, the third filtering membrane 15, located downstream of the second membrane 14, has pores of which the size is between 0.01 μm and 0.1 μm.

During the circulation of the coolant in the tube 10, the various membranes 13, 14 and 15 become clogged according to the quantity and the nature of the corrosion products in the coolant. The clogging of each one of the membranes 13, 14, 15 is monitored in-line by an operator by differential pressure sensors 16 that measure the difference in the pressure of a fluid between the upstream and the downstream of each one of the membranes 13, 14, 15. Using the measurements taken by the differential pressure sensors 16, the nature and the concentrations of the corrosion products can be estimated by comparison with the standards.

The coolant exiting the filtration apparatus 11 is then collected for reprocessing.

After in-line analysis of the corrosion products, the membranes can be removed and recovered for additional analyses in such a way as to obtain more specific information on the chemical and/or morphological nature of the colloids.

The tube 10 more specifically comprises a means of cooling 12, positioned upstream of the filtration apparatus 11, in such a way as to cool if necessary the fluid circulating in the circuit 1, for example when the reactor is in nominal operation, the primary coolant can be sampled at a temperature between 260° C. and 320° C. and at a pressure between 60 bars and 150 bars. As such, when the coolant passes through the filtering apparatus 11 for characterisation, the fluid is cooled to a low temperature (i.e. between 18° C. and 25° C.).

1. A system for the in-line characterisation of corrosion products in a cooling system of a nuclear reactor, said characterisation system comprising:
a tube for connection to the cooling system of the reactor in which the coolant circulates;
at least two filters arranged in series, a downstream filter of the at least two filters having a pore size less than a filter of the at least two filters located upstream, with the at least two filters to be passed therethrough by the coolant;
differential pressure sensors associated with each one of the at least two filters which make it possible to determine in-line an obstruction rate of each of the at least two filters.

2. The system for the in-line characterisation of corrosion products in a cooling system of a nuclear reactor as claimed in claim 1, wherein the at least two filters include three filters arranged in series having different filtering characteristics.

3. The system for the in-line characterisation of corrosion products in a cooling system of a nuclear reactor as claimed in claim 2, wherein a first of the three filters has pores of which the size is between 3 μm and 5 μm.

4. The system for the in-line characterisation of corrosion products in a cooling system of a nuclear reactor according to claim 3, wherein a second of the three filters has pores of which the size is between entre 0.4 μm and 0.6 μm.

5. The system for the in-line characterisation of corrosion products in a cooling system of a nuclear reactor according to claim 4, wherein a third of the three filters has pores of which the size is between 0.01 μm and 0.1 μm.

6. The system for the in-line characterisation of corrosion products in a cooling system of a nuclear reactor according to claim 1, further comprising, upstream of the at least two filters, a cooling system configured to cool the fluid circulating in the system.

7. The system for the in-line characterisation of corrosion products in a cooling system (1) of a nuclear reactor as claimed in claim 6, wherein the cooling system is configured to cool the coolant between 18° C. and 25° C.

8. The system for the in-line characterisation of corrosion products in a cooling system of a nuclear reactor according to claim 1, further comprising a pressure system for maintaining a pressure between 1 and 15 bars on the at least two filters.

9. The system for the in-line characterisation of corrosion products in a cooling system of a nuclear reactor according to claim 1, wherein each of the at least two filters is formed by a membrane.
